(19) United States
(12) Patent Application Publication
(10) Pub. No.: US 2003/0037413 A1
(43) Pub. Date: Feb. 27, 2003

(54) Tool handle

(76) Inventor: Armin Sebastian Tay, West Covina, CA (US)

Correspondence Address: ARMIN S. TAY, 2599 E. TEMPLE AVE., APT. I, WEST COVINA, CA, 91792, US

(21) Appl. No.: 10/223,814

(22) Filed: Aug. 20, 2002

Related U.S. Application Data
(60) Provisional application No. 60/314,464, filed on Aug. 23, 2001.
(60) Provisional application No. 60/322,717, filed on Sep. 17, 2001.
(60) Provisional application No. 60/342,448, filed on Dec. 19, 2001.

(51) Int. Cl. E05B 1/00

(52) U.S. Cl. 16/422

(57) ABSTRACT

A tool handle that can easily be secured to tool sticks of various diameters at any axial position of the tool stick and can easily be removed from a tool stick. The tool handle has at least one pushing surface that can be used by a user to push or pull the tool stick in the direction along its length; so that the gripping force required to push or pull the tool stick is eliminated. For Tool Handle #1 and #2 the pushing surface is provided by the top surface of outer part 22 or alternate outer part 26. And for Tool Handle #3 to #8, the pushing surface(s) is provided by hand flange(s) (30FH, 40FH, 50FH, or 60FH).

### BACKGROUND—CROSS REFERENCE TO RELATED APPLICATONS

This invention is entitled to the benefit of Provisional Patent Application Ser. No. 60/314,464, Filed Aug. 23, 2001 Provisional Patent Application Ser. No. 60/322,717 filed Sep. 17, 2000 and Provisional Application Ser. No. 60/342,448 filed Dec. 19, 2001.

### BACKGROUND—FIELD OF INVENTION

This invention relates to tools, such as brooms, rakes, and shovels. Specifically it relates to a tool handle that can easily be attached anywhere along the length of tool stick, and easily be removed from a tool stick. When attached, the tool handle provides a pushing surface that a user can use to push or pull a tool stick in the direction along its length; this can eliminate the gripping force required to push or pull the tool stick.

### BACKGROUND—DESCRIPTION OF PRIOR ART

Tools such brooms and rakes are extensively used for cleaning purposes. In order to use this tools often times the user has to grip the stick of the tool in order to exert a pushing or pulling action along the length of the stick of the tool. This gripping action reduces the efficiency and comfort of the person using the tool, and can cause injury to the person using the tool.

### SUMMARY

In accordance with the present invention a tool handle, with at least one pushing surface, which can easily be attached to tool sticks of various diameters at any position along the length of the tool stick.

### OBJECTS AND ADVANTAGES

Accordingly, besides the objectives and advantages of the tool handle described in my above patent, several objectives and advantages of the present invention are:

(a) To provide a tool handle with a pushing surface that can be used to eliminate the gripping force required in order to apply a pushing or pulling force along the length of a tool stick.

(b) To provide a tool handle that increases the comfort and efficiency of the person using the tool mainly due to the elimination of the gripping force.

(c) To provide a tool handle that can easily be attached to and removed from tool sticks of various diameters.

(d) To provide a tool handle which can be positioned anywhere along the length of the tool stick. Still further objects and advantages will become apparent from a consideration of the ensuing description and drawings.

### DRAWING FIGURES

In the drawings, closely related figures have the same number but different alphabetic suffixes.

FIG. 1 shows a side-view of Tool Handle #1, which attached to a tool stick.

FIG. 2 shows a side-view of Tool Handle #2, which is attached to a tool stick.

FIG. 3A shows a side-view of Tool Handle #3, which is attached to a tool stick.

FIG. 3B shows a top-view of Tool Handle #3, which is attached to a tool stick.

FIG. 4 shows a side-view of Tool Handle #4, which is attached to a tool stick.

FIG. 5A shows a side-view of Tool Handle #5, which is attached to a tool stick.

FIG. 5B shows a top-view of Tool Handle #5, which is in its fastening position.

FIG. 5C shows a top-view of Tool Handle #5, which is in its released position.

FIG. 6 shows a side-view of Tool Handle #6, which is attached to a tool stick.

FIG. 7A shows a side-view of Tool Handle #7, which is attached to a tool stick.

FIG. 7B shows a top-view of Tool Handle #7, which is attached to a tool stick

FIG. 8 shows a side-view of Tool Handle #8, which is attached to a tool stick.

FIG. 9 shows a push-broom to which a Tool Handle #1 is attached

FIG. 10 shows a rake to which a Tool Handle #3 is attached

### REFERENCE NUMERALS IN DRAWINGS

10 tool shaft

12 broom head

14 rake head

20 inner part

20T inner part top shape

20B inner part bottom shape

20TR inner part threads

20C inner part cover

20SG inner part gripping surface

20CT inner part cut-out section

22 outer part

22T outer part top shape

22B outer part bottom shape

26 alternate outer part

26T alternate outer part top shape

26 B alternate outer part bottom shape

30 molded part #A

30FH molded part #A hand flange

30S molded part #A sleeve

30FB molded part #A bolt flange

32 clamping bolt

34 clamping nut

40 molded part #B

40FH molded part #B hand flange

40S molded part #B sleeve

40FB molded part #B bolt flange

50 molded part #C

50FH molded part #C hand flange

50S molded part #C sleeve

50FV molded part #C rivet flange

50HK molded part #C hook

52 clamp actuator

52SE clamp actuator stem

52HL clamp actuator left hole

52HR clamp actuator right hole

54 clamp rivet

54H clamp rivet head

54E clamp rivet end

54E clamp rivet ends

54H clamp rivet head

56 clamp sling

56E clamp sling ends

60 molded part #D

60FH molded part #D hand flange

60S molded part #D sleeve

60HK molded part #D hook

70 actuator pin

70E actuator pin end

70FR actuator pin rubber flange

70FG actuator pin bonding flange

72 hook pin

72E hook pin end

72FR hook pin rubber flange

74 clamp rubber

### DESCRIPTION OF INVENTION

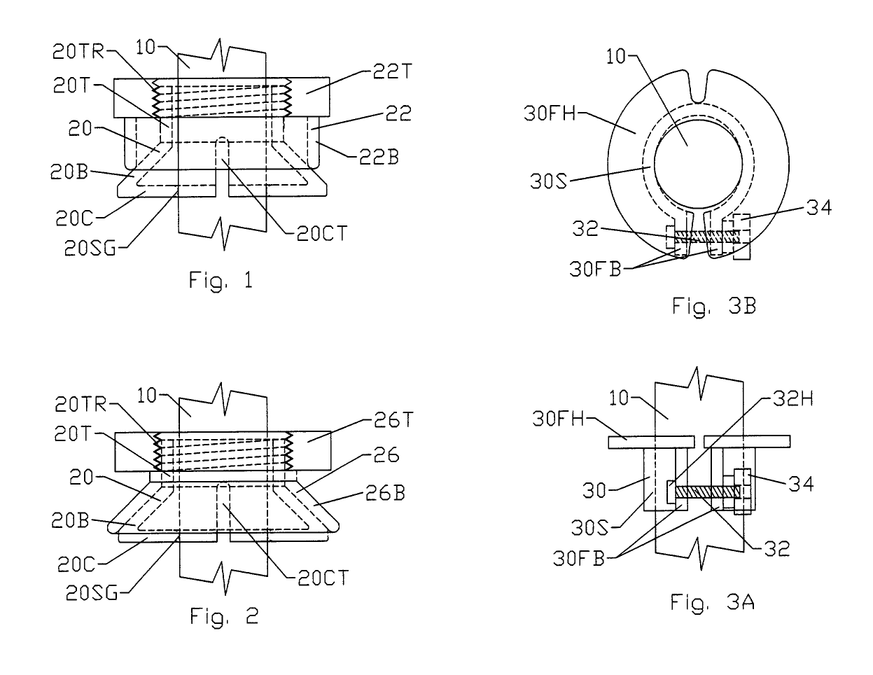

FIG. 1—Preferred Embodiment (Tool Handle #1)

The side-view of the preferred embodiment, which is labeled as Tool Handle #1, is shown in FIG. 1. It consists of an inner part 20 and an outer part 22. Inner part 20 consist of two shapes, the top shape of inner part 20, which is labeled as inner part top shape 20T, is shaped like a sleeve that can be slid unto the stick of a tool; while the bottom shape of inner part 20, which is labeled as inner part bottom shape 20B, is shaped like a cone. The upper portion of the outer surface of inner part top shape 20T has threads, which are labeled as inner part threads 20TR. The bottom shape of inner part 20 has two inner part cut-out sections 20CT, which are placed opposite from each other. In addition at its bottom, the inner part bottom shape 20B has an inner part cover 20C. Inner part cover 20C is shaped like a donut with two cut-out sections due to the inner part cut-out sections 20CT. The inner surface of inner part cover 20C has an inner part gripping surface 20SG. The inner part cut-out sections 20CT, mentioned earlier, allow the inner part bottom shape 20B to flex, which will then allow inner part gripping surface 20SG to grip tool sticks of various diameters. The outer part 22 also consists of two shapes. The bottom shape, which is labeled as outer part bottom shape 22B, is shaped like shaped like sleeve. The top end of outer part bottom shape 22B is joined to outer part top shape 22T, while the bottom surface of outer part bottom shape 22B engages with the inner part bottom shape 20B. The bottom surface of outer part bottom shape 22B is rounded, as to minimize the stress between the engaging surfaces of outer part bottom shape 22B and inner part bottom shape 20B. The outer part top shape 22T is basically an enlarged nut which is threaded unto inner part threads 20TR. When tighten, outer part top shape 22T pushes outer part bottom shape 22B towards inner part 20, this creates a wedging action that pushes the inner part gripping surfaces 20SG towards the tool stick. And unless the tool stick is of an unusually small diameter, this cause the inner part gripping surfaces 20SG to grip the tool stick; and this, fixes the position of tool handle #1 on the tool stick.

FIG. 2—Alternate Embodiment 1 (Tool Handle #2)

An alternate embodiment of this invention, labeled as Tool Handle #2, is shown in FIG. 2 (side-view). Tool Handle #2 is identical to Tool Handle #1, except here outer part 22 is replaced with an alternate outer part 26.

Alternate outer part 26 has the same function as outer part 22, however it is shaped differently. Here the alternate outer part top shape 26T, is identical to the outer part top shape 22T, so that it is also shaped like an enlarged nut. However, the alternate outer part bottom shape 26B is shaped differently. The alternate outer part bottom shape 26B has a top shape and a bottom shape. The top shape is shaped like a sleeve and the bottom shape is shaped like a cone. The top end of alternate outer part bottom shape 26B is bonded to the alternate outer part top shape 26T. Alternate outer part 26 is placed on top of inner part 20 in a manner such that the alternate outer part bottom shape 26B engages with the inner part bottom shape 20B.

FIGS. 3A and 3B—Alternate Embodiment 2 (Tool Handle #3)

Another embodiment of the invention, labeled as Tool Handle #3, is shown in FIG. 3A (side-view) and FIG. 3B (top-view). It consists of a molded part #A 30, a clamping bolt 32, and a clamping nut 34. The molded part #A 30 is shaped such that it has a molded part #A sleeve 30S that has a radial gap; a molded part #A hand flange 30FH, molded at the top end of sleeve 30; and two molded part #A bolt flanges 30FB, molded to the side surface of molded part #A sleeve 30S near its radial gap. The two molded part #A bolt flanges 30FB, each have a hole through which clamping bolt 32 is inserted. A clamping nut 34 is mated with clamping bolt 32 in a manner such that the molded part #A bolt flanges 30FB are sandwiched by clamping bolt head 32H and clamping nut 34. Here, tightening clamping nut 34 pushes the molded part #A bolt flanges 30FB closer together; and this causes the inner surfaces of molded part #A sleeve 30S to grip the tool stick.

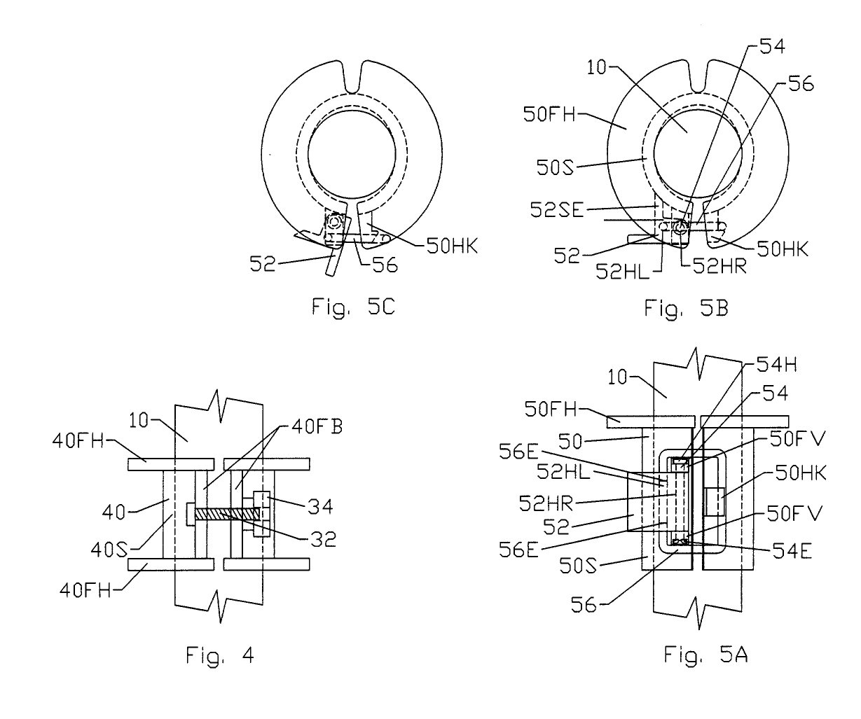

FIG. 4—Alternate Embodiment 3 (Tool Handle #4)

A slight variation of Tool Handle #3 is shown in FIG. 4. This embodiment, which will be referred to as Tool Handle #4, is identical to Tool Handle #3 except that here molded part #A 30 is replaced with molded part #B 40. Molded part #B 40 is identical to molded part #A 30, except that here, a hand flange, which here is labeled as molded part #B hand flange 40FH instead of molded part #A hand flange 30FH, is molded to the top and bottom end of its sleeve, which here is labeled as molded part sleeve #B 40S instead of molded part sleeve #A 30S.

FIGS. 5A, 5B, 5C—Alternate Embodiment 4 (Tool Handle #5)

Another embodiment of this invention, referred to as Tool Handle #5, is shown in FIG. 5A (side-view), FIG. 5B (top-view fastened position), FIG. 5C (top-view released position). It is similar to Tool Handle #4 except that for it fastening means, it uses a clamping mechanism instead of the nut-and-bolt mechanism.

Tool Handle #5 consist of a molded part #C 50, a clamp actuator 52, a clamp rivet 54, and a clamp sling 56. The molded part #C 50 is shaped that it has a molded part #C sleeve 50S, which has a radial gap; a molded part #C hand flange 50FH that is molded on to the top end of molded part #C sleeve 5OS; two molded part #C rivet flanges 50FV, which are molded to the side surface of molded part #C sleeve 50S on the left side of the gap of molded part #C sleeve 50S, and a molded part #C hook 50HK that is molded to the side surface of molded part #C sleeve 50S on the right side of the gap of molded part #C sleeve 50S.

The clamp actuator 52 is shaped like an inverted T, where the stem, labeled as clamp actuator stem 52SE, is pointing upwards and the outer surfaces of the flanges are facing downwards. The left flange of the inverted-T shaped clamp actuator 52 provides a surface that a user can use to fasten or release the clamping mechanism. The right flange has two holes, the left hole, labeled as clamp actuator left hole 52HL, is used to attach clamp sling 56, and the right hole, labeled as clamp actuator right hole 52HR, is used to attach the clamp actuator 52 to the molded part #C 50.

In order to attach clamp actuator 52 to molded part #C 50, clamp actuator 52 is placed between the molded part #C rivet flanges 50FV, and aligned such that the clamp actuator right hole 52HR is aligned with the holes of rivet flanges 50FV. Then clamp rivet 54, which end portion consists of two separate rods each labeled as clamp rivet end 54E, is inserted through the clamp actuator right hole 52HR and the holes of clamp rivet flanges 50FV. Next the clamp rivet ends 54E are bent such that they engage with the bottom surface of the bottom of clamp rivet flange 50FV. This engagement, in addition to the engagement between the clamp rivet head 54H, and the top surface of the top clamp rivet flange 50FV, securely attaches clamp rivet 54 and clamp actuator 52 to the molded part #C 50. Also, the diameter of clamp rivet 54 is small enough as to allow clamp actuator 52 to pivot freely on clamp rivet 54.

In its finished form, clamp sling 56 is basically a square-C that is formed from a round wire; where its ends, which are labeled as clamp sling ends 56E and are located at the open side of the square-C shape, are inserted into the clamp actuator left hole 52HL; and the closed end of the square-C shape can be engaged or disengaged with the molded part #C hook 50HK. However before the ends of the clamp sling ends 56E are inserted into the clamp actuator left hole 52HL, the top and bottom member of clamp sling 56 are bent outwards such that clamp sling ends 56E can be positioned as to sandwich the clamp actuator left hole 52HL. And once the clamp sling ends 56E are aligned with the clamp actuator left hole 52HL, they are inserted into the clamp actuator left hole 52HL by bending the top and bottom member of clamp sling 56 as to form the square-C shape. Also, the diameter of the wire that forms clamp sling 56 is small enough as to allow clamp sling 56 to pivot freely in the clamp actuator left hole 52HL.

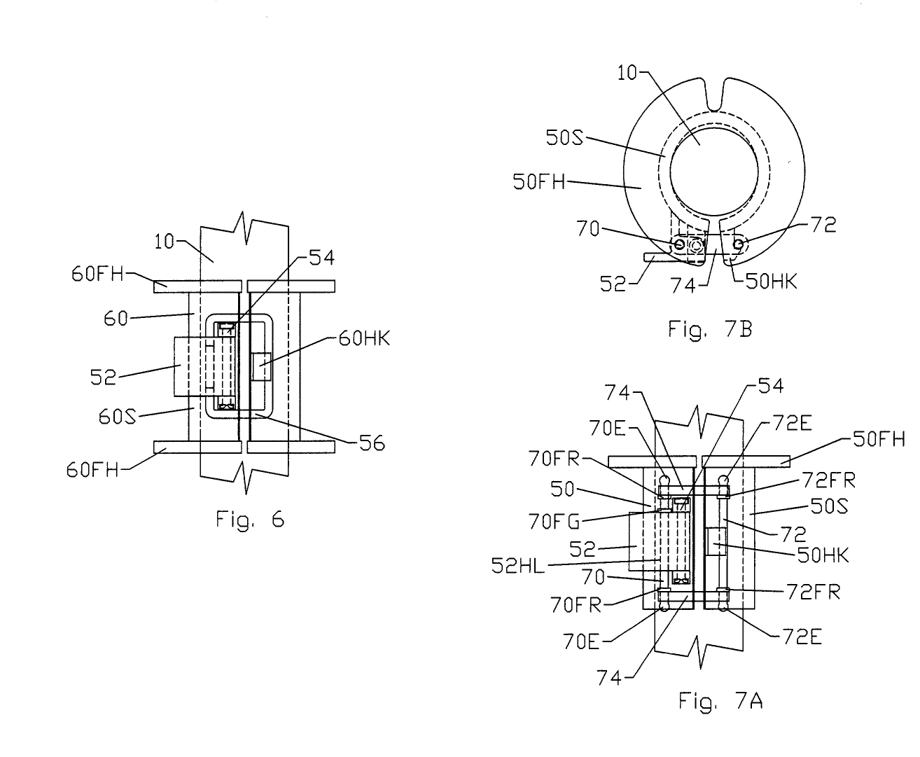

FIG. 6—Alternate Embodiment 5 (Tool Handle #6)

A slight variation of Tool Handle #5 is shown in FIG. 6. This embodiment, which will be referred to as Tool Handle #6, is identical to Tool Handle #5 except that here molded part #C 50 is replaced with molded part #D 60. Molded part #D 60 is identical to molded part #C 50, except that here, a hand flange, which here is labeled as molded part #D hand flange 60FH instead of molded part #C hand flange 50FH, is molded to the top and bottom end of its sleeve, which here is labeled as molded part #D sleeve 60S instead of molded part #C sleeve 50S.

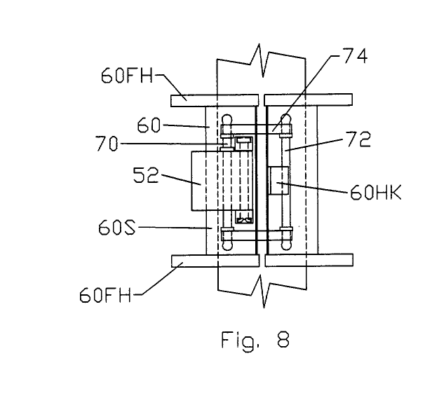

FIGS. 7A and 7B—Alternate Embodiment 6 (Tool Handle #7)

Another slight variation of Tool Handle #5 is shown in FIG. 7A (side-view) and FIG. 7B (top-view). This embodiment, which is labeled as Tool Handle #7, uses the same molded part 50 and clamp actuator 52 used in Tool Handle #5. However, for Tool Handle #7, the C-shaped clamp sling 56 is replaced by an actuator pin 70, a hook pin 72, and a clamp rubber 74.

Actuator pin 70 is a pin which is shaped such that its top and bottom ends have a round enlargement which is labeled as actuator pin end 70E. And slightly below the top actuator pin end 70E and slightly above the bottom actuator pin end 70E, a flange, which is labeled as actuator pin rubber flange 70FR, exists. In addition, an actuator pin bonding flange 70FG, located between the top and bottom actuator pin rubber flanges 70FR, also exists.

In order to securely attach actuator pin 70 to clamp actuator 52, a bonding agent is applied to the bottom surface of the actuator pin bonding flange 70FG. Then actuator pin 50 is inserted through the clamp actuator left hole 52HL in a manner such that the bottom surface of the actuator pin bonding flange 50FG bonds with the upper surface of clamp actuator 52. Here, replacing clamp actuator 52 and actuator pin 70 with a clamp actuator 52 to which actuator pin 70 is molded on would also work.

The shape of hook pin 72 is identical to actuator pin 70, except that hook pin 72 does not have an actuator pin bonding flange 70FG. Like actuator pin 70, it has a top end and bottom end enlargement, which here are labeled as hook pin ends 72E instead of actuator pin ends 70E, and flanges located near its hook pin ends 72E, which here are labeled as hook pin rubber flange 72FR instead of actuator pin rubber flange 70FR.

A clamp rubber 74, which can allow for greater variation in tool stick diameter, is a rubber strip that has a hole at each of its ends. One clamp rubber 74 is used to connect the top portion of actuator pin 70 with the top portion of hook pin 72, while the other clamp rubber 74 is used to connect the bottom portion of actuator pin 70 with the bottom portion of hook pin 72. In order to connect the top portion of actuator pin 70 to the top portion of hook pin 72, the top actuator pin end 70E is pushed through one hole of a clamp rubber strip 74 until the bottom surface of the clamp rubber 74 rest on the top actuator pin rubber flange 70FR, and the top hook pin end 72E is pushed through the other hole of the same clamp rubber 74 until the bottom surface of the clamp rubber 74 rest on the top hook pin rubber flange 72FR. The bottom portion of actuator pin 70 and the bottom portion of actuator pin 72 are joined by the other clamp rubber 74 in the same manner as top portion.

FIG. 8—Alternate Embodiment 7 (Tool Handle #8)

A slight variation of Tool Handle #7 is shown in FIG. 8. This embodiment, which will be referred to as Tool Handle #8, is identical to Tool Handle #7 except that here molded part #C 50 is replaced with molded part #D 60. Molded part #D 60 is identical to molded part #C 50, except that here, a hand flange, which here is labeled as molded part #D hand flange 60FH instead of molded part #C hand flange 50FH, is molded to the top and bottom end of its sleeve, which here is labeled as molded part #D sleeve 60S instead of molded part #C sleeve 50S.

Advantages

From the description above, a number of advantages of my tool handle become evident:

(a) The tool handle, which can eliminate the gripping force required to push a tool stick along its length, can be easily attached to or removed from tool sticks of various diameters.

(b) The position of the tool handle along the length of the tool stick to which it is attached can easily be changed.

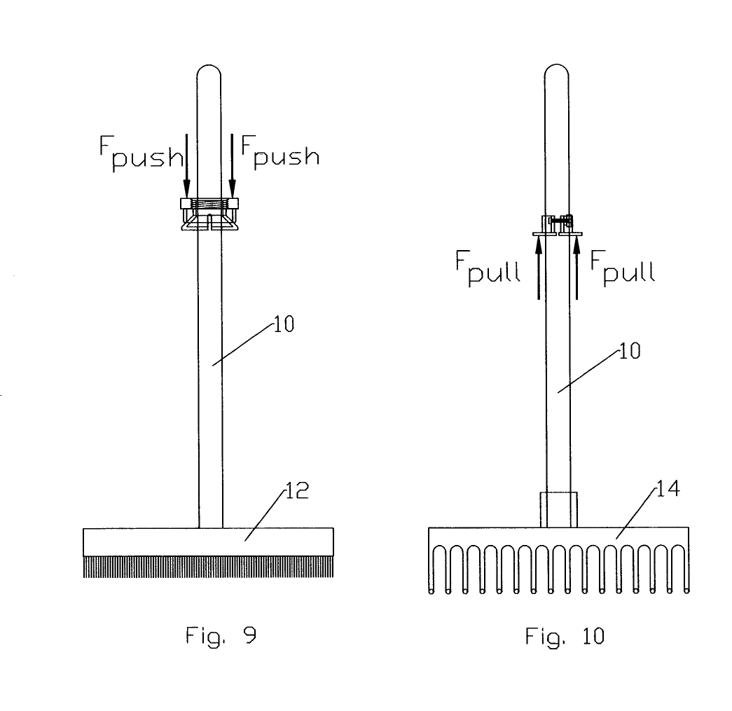

OPERATION OF INVENTION—FIGS. 9 and 10

In order to use a tool handle of this invention, the user first slides a tool handle unto a tool stick in a manner such that the top surface of an outer part 22, the top surface of an alternate outer part 26, or the surface(s) of one or several hand flanges (30FH, 40FH, 50FH, or 60FH) can provide surface(s) that can be used to push, pull, or both push and pull a tool stick in the direction along its length.

When used on tools were the user primarily pushes the tool to accomplish his/her work, such as in push brooms, the tool handle should be attached to the tool stick such that the top surface of outer part 22, alternate outer part 26, or a hand flange (30FH, 40FH, 50FH, or 60FH) can be used to push the tool (see FIGS. 1, 2, 3A, 5A, 7A, and 9). And when used in tools were the user primarily pulls the tool to accomplish his/her work, such as in rakes, the tool handle should be attached to the tool stick such the top surface of outer part 22, alternate outer part 26, or a hand flange (30FH, 40FH, 50FH, or 60FH) can be used to push the tool (see FIG. 1, 2, 3A, 5A, 7A, and 10).

If the user wants both a surface to push a tool stick and a surface to pull a tool stick, the user can use two tool handles attached as to sandwich the hand of the user when he/she grips the tool stick. Or the user can use a Tool Handle #1, a Tool Handle #2, a Tool Handle #4, Tool Handle #6, or a Tool Handle #8. For Tool Handle #1 and Tool Handle #2, the top surface of outer part 22 or alternate outer part 26 can be used as a pushing surface and the inner part cover 20C can be used as the pulling surface, or vice-versa (see FIGS. 1 and 2). On the other hand, Tool Handle #4, Tool Handle #6, and Tool Handle #8 each have two hand flanges (30FH, 40FH, 50FH, or 60FH), so one hand flange can be used as a pushing surface, and the other hand flange can be used as a pulling surface (see FIGS. 4, 6, and 8). However, if only one Tool Handle #1, #2, #4, #6, or #8 is used to provide both a pulling surface and a pushing surface, the user needs to change his/her gripping position on the tool stick when the user wants to change the type (pushing/pulling) of surface he/she wants to use.

Once the user has properly placed and positioned a tool handle on the tool stick, the user needs to fasten the tool handle to the tool stick to prevent any relative movement between the tool handle and the tool stick. The method of fastening and releasing of the various tool handles presented in the previous section will be discussed below:

Fastening and Releasing of Tool Handle #1 and Tool Handle #2—FIGS. 1 and 2

In order to fasten Tool Handle #1 and Tool Handle #2 to a tool stick, the user rotates outer part 22 or alternate outer part 26 clockwise until the inner part gripping surface 20SG securely grips on to the tool stick. And in order to release Tool Handle #1 and Tool Handle #2, the user rotates outer part 22 or alternate outer part 26 counter-clockwise until inner part gripping surface 20 releases its grip on the tool stick.

Fastening and Releasing of Tool Handle #3 and Tool Handle #4—FIGS. 3A, 3B, 4

In order to fasten Tool Handle #3 and Tool Handle #4 to a tool stick, first the user needs to make sure that clamping bolt 32 is inserted through the holes of both bolt flanges of its molded part (30FB or 40FB), and that the head of clamping bolt 32 is resting on the outer surface of the left bolt flange of its molded part (30FB or 40FB). Then the user screws on clamping nut 34 to clamping bolt 32 until the inner surfaces of the sleeve of its molded part (30S or 40S) are sufficiently pushed close together to securely grip the surface of the tool stick. And in order to release Tool Handle #3 and Tool Handle #4, the user simply releases the tension in clamping bolt 32 that pushes the inner surfaces of sleeve 30S or 40S closer together, by unscrewing clamping nut 34 from clamping bolt 32.

Fastening and Releasing of Tool Handle #5 and Tool Handle #6—FIGS. 5A, 5B, 5C, 6

In order to fasten Tool Handle #5 and Tool Handle #6 to a tool stick, first the closed end of the square-C shaped clamp sling 56 is engaged with the hook of its molded part (50HK or 60HK). Then clamp actuator 52 is rotated clock-wise until the clamp actuator stem 52SE hits the surface of the sleeve of its molded part (50S or 60S) (see FIG. 5B). This should put the top and bottom member of the square-C shaped clamp sling 56 in tension, which causes the sleeve of its molded part (50S or 60S) to securely grip the tool stick. And in order to release Tool Handle #5 and Tool Handle #6, the user releases the tension in the top and bottom member of clamp sling 56 by rotating clamp actuator 52 counter-clockwise.

Fastening and Releasing of Tool Handle #7 and Tool Handle #8—FIGS. 7A, 7B, 8

In order to fasten Tool Handle #7 and Tool Handle #8 to a tool stick, first hook pin 72 is engaged with the hook of its molded part (50HK or 60HK). Then clamp actuator 52 is rotated clock-wise until the clamp actuator stem 52SE hits the surface of the sleeve of its molded part (50S or 60S) (see FIG. 5B). This should put the top and bottom clamp rubber 74 in tension, which causes the sleeve of its molded part (50S or 60S) to securely grip the tool stick. And in order to release Tool Handle #5 and Tool Handle #6, the user releases the tension in the top and bottom clamp rubber 74 by rotating clamp actuator 52 counter-clockwise.

Once one or several tool handles have been properly positioned and fastened to a tool stick, the user can use the pushing surfaces of the tool handles to push or pull the tool stick.

CONCLUSION, RAMIFICATION, AND SCOPE

Accordingly, the reader will see that the tool handles of this invention can provide a pushing surface, which can be used to eliminate the gripping force required to push or pull a tool stick. This should increase the efficiency and comfort of the person using the tool significantly. In addition the tool handle of this invention are designed such that:

they can be easily fasten to or released from tool sticks of various sizes;

they can be fastened at any axial position of the tool stick, as to provide maximum comfort for the user;

they can be made of various materials and various colors, as to aesthetically please the user;

they can function as a removable label for a tool stick;

Although the description above contains many specificities, these should not be construed as limiting the scope of the invention but as merely providing illustrations of some of the presently preferred embodiments of this invention. For example, other shapes of tool handles can be designed. For example, in order to reduce or eliminate the gripping force required to push or pull a tool stick, a handle that has a griping sleeve with hand grooves can be designed. Or, a tool handle that has two hand flanges that sandwich a gripping sleeve, which can used by the user to grip the handle, can also be designed. Furthermore, the materials used to construct the flanged tool handles can be changed. For example, for some or all parts instead of plastic other materials such as steel or rubber can be used. In addition, fastening means other than the ones described in this application can be used to securely attach a tool handle to a tool stick. Some of the fastening means that might work are a loop and hook fastener, a tying string fastener, and a belt and buckle fastener. Other uses of the tool handles of this invention are also possible.

Thus the scope of the invention should be determined by the appended claims and their legal equivalents, rather than by the examples given.

I claim:

1. A tool handle that can be attached to tool sticks.

2. The tool handle that can easily be fastened to or removed from tool sticks of various diameters.

3. Said tool handle of claim 2, wherein means for fastening said tool handle to said tool stick uses the wedging action between an outer part and an inner part.

4. Said tool handle of claim 2, wherein means for fastening said tool handle to said tool stick uses a clamping mechanism.
